(19) United States
(12) Patent Application Publication
(10) Pub. No.: US 2025/0238992 A1
(43) Pub. Date: Jul. 24, 2025

(54) TECHNIQUES FOR GENERATING A GENERALIZED PHYSICAL FACE MODEL

(71) Applicants: DISNEY ENTERPRISES, INC., Burbank, CA (US); ETH Zürich (Eidgenössische Technische Hochschule Zürich), Zürich (CH)

(72) Inventors: Derek Edward BRADLEY, Zürich (CH); Lingchen YANG, Zürich (CH); Gaspard ZOSS, Zürich (CH); Prashanth CHANDRAN, Zürich (CH); Barbara SOLENTHALER, Zürich (CH); Eftychios Dimitrios SIFAKIS, Verona, WI (US)

(21) Appl. No.: 19/033,346

(22) Filed: Jan. 21, 2025

Related U.S. Application Data
(60) Provisional application No. 63/624,216, filed on Jan. 23, 2024.

(51) Int. Cl. G06T 13/40; G06T 17/20

(52) U.S. Cl. CPC G06T 13/40; G06T 17/20

(57) ABSTRACT

The present invention sets forth techniques for generating a facial animation. The techniques include receiving a latent identity code including a first set of features describing a neutral facial depiction associated with an identity and receiving a latent expression code including a second set of features describing a facial expression associated with the identity. The techniques also include generating, via a first machine learning model, an identity-specific facial representation based on a canonical facial representation and the latent identity code and generating, via a second machine learning model and based on the latent identity code, the latent expression code, and the identity-specific facial representation, a muscle actuation field tensor and one or more bone transformations associated with the deformed canonical facial representation. The techniques further include generating, via a physics-based simulator, a facial animation based on at least the muscle actuation field tensor and the one or more bone transformations.

### CROSS-REFERENCE TO RELATED APPLICATIONS

This application claims priority benefit to U.S. Provisional application titled “TECHNIQUES FOR GENERATING A GENERALIZED PHYSICAL FACE MODEL,” filed on Jan. 23, 2024, and having Ser. No. 63/624,216. This related application is also hereby incorporated by reference in its entirety.

### BACKGROUND

### Field of the Various Embodiments

Embodiments of the present disclosure relate generally to 3D computer modeling and animation and, more specifically, to techniques for generating a generalized physical face model.

### Description of the Related Art

In the field of 3D computer animation, physics-based animation models, such as face models, provide artists with animation rigs that realistically obey physical properties. For example, physics-based face models may respond to external forces such as gravity, detect and avoid collisions between physical features included in the model, and respect anatomical structures, such as bone, skin, and tissue volume.

One existing technique for generating physics-based face models includes manually constructing a separate, person-specific model for each character to be animated. These techniques include defining a facial anatomy and building a physics-ready volumetric simulation mesh representing the soft tissues included in the face model. Manual construction is time-consuming, and may require several iterative attempts by one or more artists to generate a satisfactory physics-based face model. Further, a person-specific model must be subsequently augmented with person-specific muscle actuations that will result in desired facial expressions. These actuations must also be parameterized by an artist-friendly rig space, e.g., blend shapes. Accordingly, these manual techniques may be limited to generating physics-based face models for a small and select set of animated characters.

Other existing techniques may learn a physics-based face model from real 3D facial scan data, such as scans generated from still or video images captured from a live or recorded performance. These techniques may train a dedicated network for each different character, and require large quantities of facial scan data for each character. Accordingly, these techniques may not generalize to a large number of different characters.

Still other existing techniques may be operable to learn muscle actuations across multiple subjects at the same time. While these learning techniques may generalize the task of creating muscle actuations associated with desired facial expressions, the techniques still require the manual creation and configuration of a person-specific physics-based face model for each character to be animated.

As the foregoing illustrates, what is needed in the art are more effective techniques for generating a generalized physical face model.

One embodiment of the present invention sets forth a technique generating a facial animation, the technique including receiving an identity code including a first set of features describing a neutral facial depiction associated with a particular identity and receiving an expression code including a second set of features describing a facial expression associated with the particular identity. The technique also includes generating, via a first machine learning model, an identity-specific facial representation based on a canonical facial representation and the identity code. The technique further includes generating, via a second machine learning model and based on the identity code, the expression code, and the identity-specific facial representation, a muscle actuation field tensor and one or more bone transformations associated with the deformed canonical facial representation, and generating, via a physics-based simulator, a facial animation based on at least the muscle actuation field tensor and the one or more bone transformations.

One technical advantage of the disclosed techniques relative to the prior art is that the disclosed techniques produce a fully generalized 3D physics-based face model trained on a large number, e.g., hundreds, of subject identities, without requiring manual per-identity configuration. The generalized physics-based face model may then be fit to any new identity, including identities not seen during training, and generate identity-aware muscle actuations which may be utilized to create identity-specific facial animations via physics-based animation techniques. The generalized physics-based face model may also be sampled in latent space to generate novel synthetic identities. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments of the present invention.

FIG. 2 is a more detailed illustration of the training engine of FIG. 1, according to some embodiments.

FIG. 3 is a flow diagram of method steps for training one or more machine learning models, according to some embodiments.

FIG. 4 is a more detailed illustration of the inference engine of FIG. 1, according to some embodiments.

FIG. 5 is a flow diagram of method steps for generating a facial animation, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

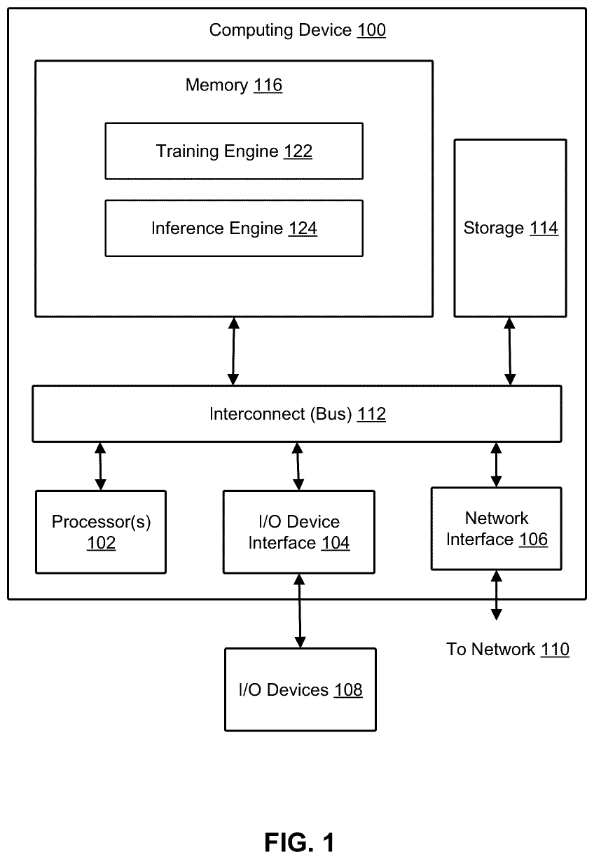

FIG. 1 illustrates a computing device 100 configured to implement one or more aspects of various embodiments of the present invention. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a training engine 122 and/or an inference engine 124 that reside in a memory 116.

It is noted that the computing device described herein is illustrative and that any other technically feasible configurations fall within the scope of the present disclosure. For example, multiple instances of training engine 122 or inference engine 124 could execute on a set of nodes in a distributed and/or cloud computing system to implement the functionality of computing device 100. In another example, training engine 122 or inference engine 124 could execute on various sets of hardware, types of devices, or environments to adapt training engine 122 or inference engine 124 to different use cases or applications. In a third example, training engine 122 or inference engine 124 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (Wi-Fi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Training engine 122 or inference engine 124 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including training engine 122 or inference engine 124.

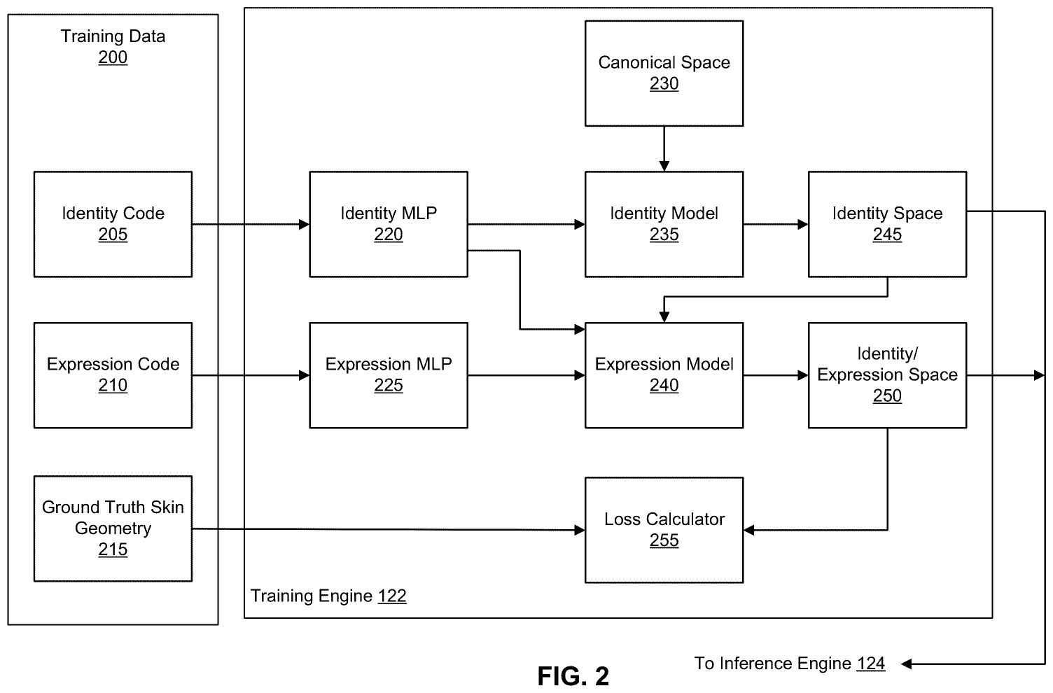

FIG. 2 is a more detailed illustration of training engine 122 of FIG. 1, according to some embodiments. Training engine 122 receives training data 200, including, e.g., thousands of 3D facial scans associated with, e.g., hundreds of different identities. Training engine 122 also includes an identity code 205, an expression code 210, and ground truth skin geometry 215 associated with each of the 3D facial scans. Training engine 122 iteratively modifies adjustable parameters included in multiple machine learning models to generate facial representations, including an identity-specific material space based on identity code 205 and a deformed identity/expression space based on both identity code 205 and expression code 210. Training engine 122 iteratively modifies the adjustable machine learning parameters based on calculated values associated with various loss functions and regularization functions. Training engine 122 includes, without limitation, identity MLP 220, expression MLP 225, canonical space 230, identity model 235, expression model 240, identity space 245, identity/expression space 250, and loss calculator 255.

### BACKGROUND: ACTUATED FACE SIMULATION

In continuum mechanics, motion is characterized by an invertible map ϕ: X∈Ω⁰→x∈Ω from the undeformed material space Ω⁰ to the deformed space Ω. The material space Ω⁰ is defined as the undeformed soft tissue space confined between the rest bones ∂Ω⁰_{bones} and skin ∂Ωₛₖᵢₙ⁰ included in representation of a face. ∂Ω_{bones}⁰ consists of the skull ∂Ωₛₖᵤₗₗ⁰ and the ∂Ω_{jaw}⁰, which will constrain and drag the soft tissue during articulation. The deformed space Ω is the soft tissue space of the target expression. The deformation gradient, F(X)=∇_{X}ϕ(X), encodes the local transformations including rotation and stretch. The quasi-static state of ϕ in the absence of external force is governed by the point-wise equilibrium:

$$div \cdot P = div \cdot \frac{\partial Ψ}{\partial F} ( F ) = 0 , \qquad Equation ( 1 )$$

where P is the first Piola-Kirchhoff stress tensor that measures the internal force. For hyperelastic material, P is associated with a specific energy density function Φ that describes the material behavior. Intuitively, Equation (1) means the net force within the material is zero everywhere. For Ψ, a shape targeting model is employed:

$$Ψ ( F , A ) = {min}_{R ∈ S O ( 3 )} {‖ F - RA ‖}_{F}^{2} = {‖ F - {R}^{*} A ‖}_{F}^{2} , \qquad Equation ( 2 )$$

where A is a symmetric actuation tensor mimicking the local muscle actuation at a single point. R* is the polar decomposition of FA, making Φ rotationally invariant.

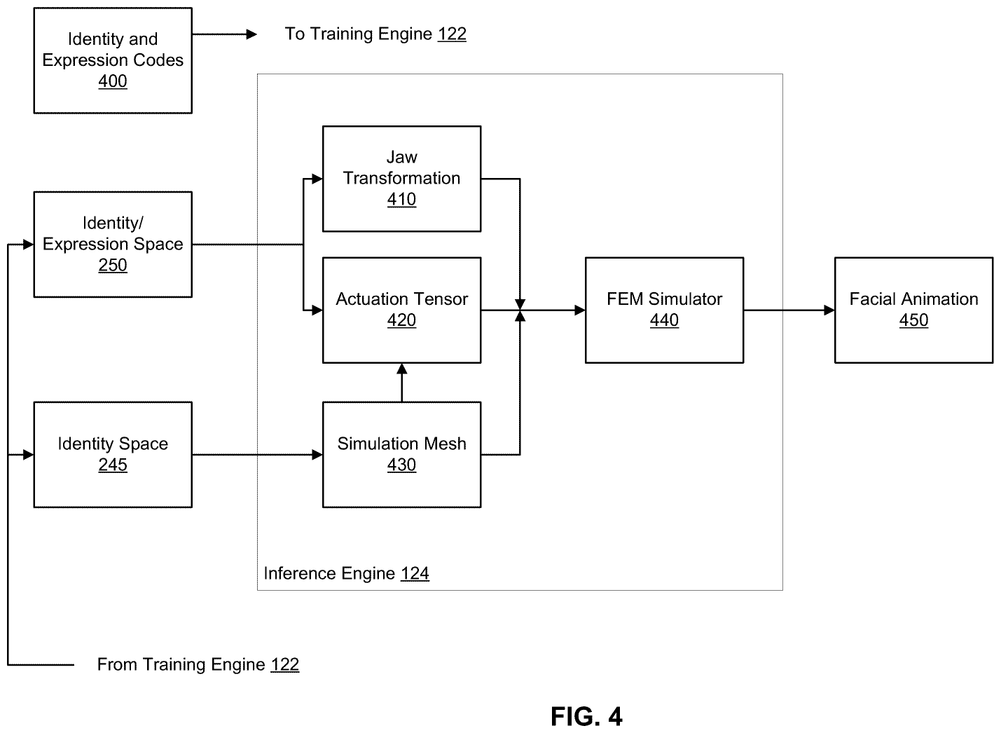

Using a simulation technique, such as a Finite Element Method (FEM) discussed below in the description of FIG. 4, Ω⁰ is uniformly discretized into a simulation mesh [symbol] ₛᵢₘ using regular elements with nodal vertices u⁰, where the discretized skin, skull and jaw are linearly embedded with barycentric weights Wₛₖᵢₙ u⁰, Wₛₖᵤₗₗ u⁰, and W_{jaw}u⁰ respectively. When the Finite Element Method applied to Equation (1), the simulation technique reduces to an energy minimization problem with respect to the deformed vertices u, such that the boundary conditions from the articulated bone are satisfied, as follows:

$${arg min}_{u} {\sum }_{e} \frac{{V}_{e}}{2} {‖ {F}_{e} ( u , {u}^{0} ) - {R}_{e}^{*} {A}_{e} ‖}_{F}^{2} \qquad Equation ( 3 )$$

$$such that [ \begin{matrix}{W}_{skull} \\ {W}_{jaw}\end{matrix} ] u = [ \begin{matrix}{W}_{skull} \\ {R}_{jaw} {W}_{jaw}\end{matrix} ] {u}^{0} + [ \begin{matrix}0 \\ {t}_{jaw}\end{matrix} ] , \qquad Equation ( 4 )$$

where Vₑ is the volume for each element e, while {R_{jaw}, t_{jaw}} denotes the rigid transformation for the jaw. As discussed below in the description of FIG. 4, the simulation technique generates an output facial animation based on the latent identity code and the latent expression code.

### Training Data and Machine Learning Model Training

Training data 200 includes a number, e.g., thousands, of 3D facial scans. Each of the 3D facial scans is associated with one of multiple, e.g., hundreds of different identities. Each of the 3D facial scans depicts an identity-specific expression, and training data 200 includes at least one 3D facial scan depicting a neutral, undeformed expression associated with each of the multiple different identities.

Training data 200 also includes, for each 3D facial scan, an associated identity code 205 and an associated expression code 210. Each of identity code 205 and expression code 210 include a set of features encoding the identity and expression, respectively, associated with the 3D facial scan. In various embodiments, each identity code 205 and expression code 210 are precomputed based on the associated 3D facial scan using any suitable 3D Morphing Model (3DMM). Ground truth skin geometry 215 associated with each 3D facial scan is derived directly from the 3D facial scan, as the 3D facial scan represents the visible skin surface. For a 3D scan included in training data 200, training engine 122 receives identity code 205, expression code 210, and ground truth skin geometry 215.

Identity MLP 220 includes a multilayer perceptron (MLP) that translates the set of features included in identity code 205 to a latent identity code (including a potentially different set of latent features. In various embodiments, identity MLP 220 accepts the first 100 principal latent features included in identity code 205 as input, and processes the features via three fully connected layers to generate a latent identity code β having 128 dimensions. Training engine 122 transmits latent identity code β to identity model 235 and expression model 240.

Similar to the operation of identity MLP 220, expression MLP 225 includes a multilayer perceptron (MLP) that translates the set of features included in expression code 210 to a latent expression code γ including a potentially different set of latent features. In various embodiments, expression MLP 220 accepts the features included in expression code 210 as input, and processes the features via three fully connected layers to generate a latent expression code γ having 128 dimensions. Training engine 122 transmits latent expression code γ to expression model 240.

Canonical space 230 includes representations of undeformed skin, bone, and soft tissue geometries. Canonical space 230 represents an initial baseline set of skin, bone, and soft tissue geometries that will later be morphed into an identity-specific configuration using identity model 235 described below. By automatically modifying canonical space 230 to generate an identity-specific configuration, the present techniques obviate the need for a user to manually define skin, bone, and soft tissue geometries associated with each different identity included in training data 200. In various embodiments, the undeformed bone geometries include geometries associated with both a skull and a jaw.

In various embodiments, training engine 122 generates canonical space 230 using any suitable parametric skeletal model, such as the SCULPTOR skeletal model. Training engine 122 obtains baseline pointwise bone and skin geometries from the skeletal model, and fits the baseline skin geometry from the skeletal model to an associated 3D facial scan included in training data 200. For each identity included in training data 200, training data 200 includes a 3D facial scan associated with the identity and depicting a neutral facial expression. Training engine 122 fits this neutral expression 3D facial scan to the skin geometry obtained from the skeletal model to obtain vertex consistency between the 3D facial scan and the pointwise skin geometry included in canonical space 230. Training engine 122 defines the pointwise soft tissue geometry included in canonical space 230 as the volumetric region located between the bones obtained from the skeletal model and the skin geometry as obtained from the skeletal model and fitted based on the neutral expression 3D facial scan. Training engine 122 transmits canonical space 230 to identity model 235.

Identity model 235 deforms bone and skin points included in canonical space 230 based on latent identity code β received from identity MLP 220, and generates identity-specific identity space 245. In various embodiments, identity model 235 includes a machine learning model having four Gaussian Error Linear Units (GeLU) that apply identity code β to the output of each of four 3D processing layers. A fifth 3D processing layer feeds into a linear output layer. The output of identity model 235 includes 3D pointwise deformations associated with each point included in canonical space 230 representing bones and skin. Identity model 235 applies the 3D pointwise deformations to canonical space 230 to generate identity space 245.

Identity space 245 includes an identity-specific representation of a facial model based on the deformation of canonical space 230 by identity model 235. Identity space 245 includes multiple points defining the locations of skin, bones, and soft tissue included in the facial model. Training engine 122 defines the soft tissue volume as including all points between the deformed skin locations and bone locations generated by identity model 235. Training engine 122 transmits identity space 245 to expression model 240. Training engine 122 may also transmit identity space 245 to inference engine 124 discussed below in the description of FIG. 4.

Expression model 240 modifies identity space 245 based on latent identity code β received from identity MLP 220 and latent expression code γ received from expression MLP 225. In various embodiments, the architecture of expression model 240 is the same or substantially similar to the architecture of identity model 235 discussed above. Based on the skin, skull, and jaw geometries included in identity space 245, expression model 240 infers a continuous muscle actuation field A(·) and a jaw transformation {R_{jaw}, t_{jaw}} to match a given expression associated with a 3D facial scan included in training data 200. In various embodiments, the skull geometry is held constant, and is not modified by expression model 240.

Expression model 240 infers the muscle actuation field and the jaw transformation subject to the follow relationships:

$${arg min}_{ϕ ( \cdot ) , A ( \cdot ) , {R}_{jaw} , {t}_{jaw}} {\int }_{\partial {Ω}_{skin}^{0}} {‖ ϕ ( X ) - {ϕ}^{`} ( X ) ‖}_{2}^{2} dX \qquad Equation ( 5 )$$

$$such that : div \cdot ( {∇}_{X} ϕ ( X ) - {R}^{*} ( X ) A ( X ) ) = 0 , ∀ X ∈ {Ω}^{0} A = {A}^{⊤} \qquad Equation ( 6 )$$

$$ϕ ( X ) = X , ∀ X ∈ \partial {Ω}_{skull}^{0} \qquad Equation ( 7 )$$

$$ϕ ( X ) = {R}_{j a w} X + {t}_{j a w} , ∀ X ∈ \partial {Ω}_{jaw}^{0} {R}_{jaw} ∈ SO ( 3 ) \qquad Equation ( 8 )$$

$$ϕ ∈ {Φ}_{b i o} \qquad Equation ( 9 )$$

Where ϕ denotes the invertible mapping function discussed above, and \grave{ϕ} denotes ground truth skin geometry 215. Equation (6) comes from the pointwise equilibrium of Equation (1) with P instantiated from Equation (2). Equation (7) and Equation (8) guarantee that the skull is fixed and that the jaw is rigidly articulated. Equation (9) constrains the mapping ϕ such that it resembles bio-mechanically plausible soft tissue deformation, referred to as the space ϕ_{bio}. Given any invertible mapping function ϕ, Equation (6) can be satisfied by setting the actuation tensor field A(·) as:

$$A ( X ) = {{R}_{ϕ} ( X )}^{⊤} {∇}_{X} ϕ ( X ) , \qquad Equation ( 10 )$$

where R_{ϕ}(X) is the polar decomposition of ∇_{X}ϕ(X) at X. This representation gives the zero-stress tensor P and hence the zero divergence everywhere. Based on this observation, expression model 240 may infer a mapping function ϕ* that approximates \grave{ϕ} while at the same time satisfying Equations (7), (8), and (9) as closely as possible.

After expression model 240 infers mapping function ϕ*, training engine 122 may calculate the continuous muscle actuation field A(·) and the jaw transformation {R_{jaw}, t_{jaw}} directly from ϕ*. Specifically, training engine 122 calculates A(·) from Equation (10) above. Training engine 122 obtains {R_{jaw}, t_{jaw}} by applying a Procrustes alignment technique between ϕ* (∂Ω_{jaw}⁰) and ∂Ω_{jaw}⁰, where ∂Ω_{jaw}⁰ denotes the jaw geometry included in canonical space 230. Training engine 122 applies the calculated continuous muscle actuation field A(·) and the jaw transformation {R_{jaw}, t_{jaw}} to identity space 245 to generate identity/expression space 250.

Identity/expression space 250 includes an identity- and expression-specific representation of a facial model based on the deformation of canonical space 230 by identity model 235 and expression model 240. Identity/expression space 250 includes multiple points defining the locations of skin, bones, and soft tissue included in the facial model. Training engine 122 defines the soft tissue volume as including all points located between the skin locations and bone locations as modified by the continuous muscle actuation field and jaw transformation calculated by expression model 240. Training engine 122 transmits identity/expression space 250 to loss calculator 255.

Loss calculator 255 evaluates one or more loss and/or regulation functions on the outputs of identity model 235 and expression model 240. In various embodiments, loss calculator 255 evaluates four loss functions associated with the output of expression model 240. These functions may include reconstruction loss [symbol] skin, rigidity loss [symbol] _{rigid}, fixation loss [symbol] _{fix}, and soft loss [symbol] _{soft}.

Reconstruction loss is defined on ∂Ωₛₖᵢₙ⁰, where ∂Ωₛₖᵢₙ⁰ denotes the skin geometry included in canonical space 230:

$${ℒ}_{skin} ( \partial {Ω}_{s k i n}^{0} ) = {\sum }_{i = 1}^{{N}_{v}} \frac{1}{{N}_{v}} {‖ {𝒩}_{e} ( {X}_{i} ) - {{x}^{`}}_{i} ‖}_{2}^{2} \qquad Equation ( 11 )$$

where Xᵢ represents the i-th sampled point from ∂Ωₛₖᵢₙ⁰, \grave{x}ᵢ indicates the corresponding ground truth position included in ground truth skin geometry 215, and [symbol] represents the operation of expression model 240. Training engine 122 samples Nᵥ points in total to be evaluated by loss calculator 255.

Rigidity Loss frigid enforces the rigidity of the bone, based on Equation (8):

$${ℒ}_{rigid} ( \partial {Ω}_{b}^{0} ) = {min}_{R ∈ S O ( 3 ) , t ∈ {R}^{3}} {\sum }_{i}^{{N}_{b}} \frac{1}{{N}_{b}} {‖ {𝒩}_{e} ( {X}_{i} ) - ( R {X}_{i} + t ) ‖}_{2}^{2} \qquad Equation ( 12 )$$

where training engine 122 samples N_{b} points in total for each region ∂Ω_{b}⁰ representing bones in the facial model as deformed by expression model 240 ( [symbol] ). Loss calculator 255 calculates this loss separately for the skull ∂Ωₛₖᵤₗₗ⁰ and the ∂Ω_{jaw}⁰. Therefore, [symbol] _{rigid}= [symbol] _{rigid} (∂Ωₛₖᵤₗₗ⁰)+ [symbol] _{rigid} (∂Ω_{jaw}⁰).

Fixation Loss [symbol] _{fix} enforces the fixation of the skull area, adapted from Equation (7):

$${ℒ}_{fix} ( \partial {Ω}_{skull}^{0} ) = {\sum }_{i}^{{N}_{f}} \frac{1}{{N}_{f}} ‖ {𝒩}_{e} ( {X}_{i} ) - {X}_{i} {‖}_{2}^{2} \qquad Equation ( 13 )$$

where training engine 122 samples N_{f} points in total on the skull area ∂Ωₛₖᵤₗₗ⁰. [symbol] (Xᵢ) represents a point located on the skull in identity/expression space 250, while Xᵢ represents a corresponding point located on the skull in canonical space 230.

Soft Loss [symbol] _{soft} learns a bio-mechanically plausible deformation of the soft tissue volume based on Young's Modulus (E) and Poisson's Ratio (v), based on Equation (9). This loss consists of two terms, an elastic one and a volume-preserving one:

$${ℒ}_{soft} ( {Ω}^{0} ) = {\sum }_{i}^{{N}_{s}} \frac{1}{{N}_{s}} {min}_{R ∈ S O ( 3 )} μ {‖ {∇}_{X} {𝒩}_{e} ( {X}_{i} ) - R ‖}_{2}^{2} + {min}_{det ( D ) = 1} λ ‖ {∇}_{X} {𝒩}_{e} ( {X}_{i} ) - D {‖}_{2}^{2} \qquad Equation ( 14 )$$

where training engine 122 samples Nₛ points in total inside the material space Ω⁰, where Ω⁰ denotes the undeformed soft tissue volume. μ and λ are the Lamé parameters, describing the material behavior. These two parameters are parameterized by E and v as λ=Ev/(1+v) (1−2v) and μ=E/2 (1+v) respectively. D is defined as a matrix with a determinant of 1, matching the dimensions, e.g., 3×3, of a deformation gradient F (X)=V_{X}ϕ(X) that encodes local transformations, including rotation and stretching. This loss not only regularizes the deformation of the soft tissue, but also implicitly connects the skin and the bone via the soft tissue in-between, ensuring that the deformation of one directly influences the other. As a result, when the output skin is supervised towards the ground truth, the jaw is also placed in a constrained position, hence inferring the jaw kinematics.

Loss calculator 255 also evaluates loss and/or regulation functions associated with the output of identity model 235. In various embodiments, these functions may include identity loss [symbol] _{id}, bone shape loss [symbol] _{bone}, and elastic regularization [symbol] _{ereg}.

Identity loss [symbol] _{id} provides supervision on the skin area, similar to Eqn. (11).

$${ℒ}_{i d} ( \partial {Ω}_{skin}^{c} ) = {\sum }_{i = 1}^{{N}_{v}} \frac{1}{{N}_{v}} {‖ {𝒩}_{c} ( {X}_{i}^{c} ) - {{X}^{`}}_{i} ‖}_{2}^{2} \qquad Equation ( 15 )$$

where [symbol] represents the operation of identity model 235, Xᵢ^{c} represents the i-th point of Nᵥ sampled points included in ∂Ωₛₖᵢₙ^{c}, and \grave{X}ᵢ indicates the corresponding ground truth position included in ground truth skin geometry 215. ∂Ωₛₖᵢₙ^{c} denotes the facial model skin as deformed solely by identity model 235, prior to processing by expression model 240.

Bone shape loss [symbol] _{bone} constrains the bone shapes generated by identity model 235. As discussed above in the description of canonical space 230, training data 200 only includes ground truth data associated with the skin surface of a 3D facial scan. Training engine 122 generates pseud-ground truth bone geometry in canonical space 230 using a parametric skeletal model which is operable to predict plausible skull and jaw shapes given a neutral 3D facial scan included in training data 200. Formally, the loss is as follows:

$${ℒ}_{bone} ( \partial {Ω}_{bones}^{c} ) = {\sum }_{i = 1}^{{N}_{b}} \frac{1}{{N}_{b}} {‖ {𝒩}_{c} ( {X}_{i}^{c} ) - {{X}^{`}}_{i} ‖}_{2}^{2} \qquad Equation ( 16 )$$

where training engine 122 samples N_{b} points on ∂Ω_{bones}^{c} in total, where [symbol] (Xᵢ^{c}) represents the bone geometry at point Xᵢ^{c} as deformed by identity model 235 ( [symbol] ), and Xᵢ is the pseudo-ground truth bone position on the bone surfaces generated by the parametric skeletal model, given ground truth skin geometry 215 included in training data 200.

Elastic regularization [symbol] _{ereg} smooths the volumetric morphing of bones, skin, and soft tissue:

$${ℒ}_{ereg} ( {Ω}^{c} ) = {\sum }_{i}^{{N}_{s}} \frac{1}{{N}_{s}} {min}_{R ∈ S O ( 3 )} {‖ {∇}_{{X}^{c}} {𝒩}_{c} ( {X}_{i}^{c} ) - R ‖}_{2}^{2} \qquad Equation ( 17 )$$

where training engine 122 samples Nₛ points on Ω_{c} in total, where Ω^{c} denotes the bones, skin, and soft tissue volume as modified by identity model 235 ( [symbol] ). This regularization also makes the training robust to any incorrect estimation from the bone prediction in Eqn. (16).

Training engine 122 regularizes the latent identity code β and the latent expression code γ using l−2 regularization [symbol] _{lreg}=∥β∥₂²+∥γ∥₂². Training engine 122 also applies Lipschitz regularization [symbol] ₗᵢₚ to identity MLP 220 and expression MLP 225. Training engine 122 modifies one or more adjustable parameters included in identity MLP 220, expression MLP 225, identity model 235, and/or expression model 240 based on the above loss and regularization functions. The complete training objective function is given by

$${ℒ}_{train} = {λ}_{skin} {ℒ}_{skin} + {λ}_{r i g i d} {ℒ}_{rigid} + {λ}_{f i x} {ℒ}_{f i x} + {λ}_{s o f t} {ℒ}_{soft} + {λ}_{i d} {ℒ}_{i d} + {λ}_{bone} {ℒ}_{bone} + {λ}_{ereg} {ℒ}_{ereg} + {λ}_{lreg} {ℒ}_{lreg} + {λ}_{lip} {ℒ}_{lip} , \qquad Equation ( 18 )$$

where λ, are balancing weights. The entire model is trained end-to-end without the need for explicit simulation of bone, skin, or tissue volume geometries. The model is supervised only on ground truth skin geometry 215, while anatomical features such as bone shapes, jaw kinematics, and muscle actuations are inferred automatically by identity model 235 and expression model 240. In various embodiments, training engine 122 may iteratively modify the one or more adjustable model parameters for a predetermined number of iterations, for a predetermined amount of time, or until the training objective function [symbol] ₜᵣₐᵢₙ is below a predetermined threshold.

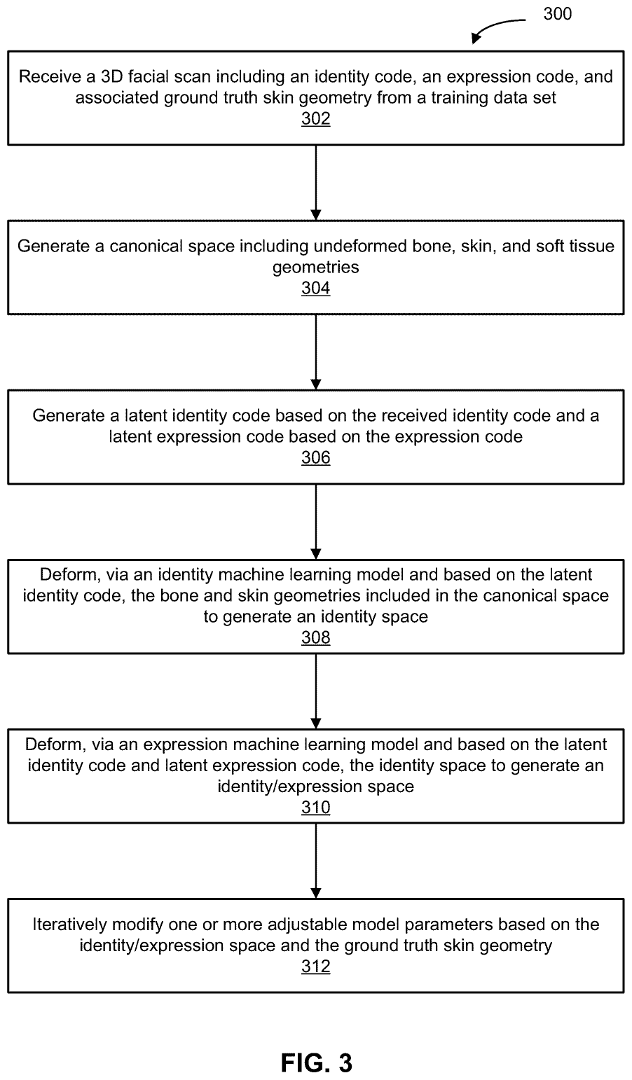

FIG. 3 is a flow diagram of method steps for training one or more machine learning models, according to some embodiments. Although the method steps are described in conjunction with the systems of FIGS. 1-2, persons skilled in the art will understand that any system configured to perform the method steps in any order falls within the scope of the present disclosure.

As shown, in step 302 of method 300, training engine 122 receives a 3D facial scan including an associated identity code 205, an associated expression code 210, and associated ground truth skin geometry 215 from training data 200.

Training data 200 includes a number, e.g., thousands, of 3D facial scans. Each of the 3D facial scans is associated with one of multiple, e.g., hundreds of different identities. Each of the 3D facial scans depicts an identity-specific expression, and training data 200 includes at least one 3D facial scan depicting a neutral, undeformed expression associated with each of the multiple different identities.

Each of identity code 205 and expression code 210 include a set of features encoding the identity and expression, respectively, associated with the 3D facial scan. In various embodiments, each identity code 205 and expression code 210 are precomputed based on the associated 3D facial scan using any suitable 3D Morphing Model (3DMM). Ground truth skin geometry 215 associated with each 3D facial scan is derived directly from the 3D facial scan, as the 3D facial scan represents the visible skin surface.

In step 304, training engine 122 generates canonical space 230. Canonical space 230 includes representations of undeformed skin, bone, and soft tissue geometries. Canonical space 230 represents an initial baseline set of skin, bone, and soft tissue geometries that will later be morphed into an identity-specific configuration using identity model 235. By automatically modifying canonical space 230 to generate an identity-specific configuration, the present techniques obviate the need for a user to manually define skin, bone, and soft tissue geometries associated with each different identity included in training data 200. In various embodiments, the undeformed bone geometries include geometries associated with both a skull and a jaw.

In various embodiments, training engine 122 generates canonical space 230 using any suitable parametric skeletal model, such as the SCULPTOR skeletal model. Training engine 122 obtains baseline pointwise bone and skin geometries from the skeletal model, and fits the baseline skin geometry from the skeletal model to an associated 3D facial scan included in training data 200. For each identity included in training data 200, training data 200 includes a 3D facial scan associated with the identity and depicting a neutral facial expression. Training engine 122 fits this neutral expression 3D facial scan to the skin geometry obtained from the skeletal model to obtain vertex consistency between the 3D facial scan and the pointwise skin geometry included in canonical space 230. Training engine 122 defines the pointwise soft tissue geometry included in canonical space 230 as the volumetric region located between the bones obtained from the skeletal model and the skin geometry as obtained from the skeletal model and fitted based on the neutral expression 3D facial scan.

In step 306, identity MLP 220 of training engine 122 generates a latent identity code β based on identity code 205, and expression MLP 225 of training engine 122 generates a latent expression code γ based on expression code 210. Identity MLP 220 includes a multilayer perceptron (MLP) that translates the set of features included in identity code 205 to latent identity code β including a potentially different set of latent features. In various embodiments, identity MLP 220 accepts the first 100 principal latent features included in identity code 205 as input, and processes the features via three fully connected layers to generate latent identity code β having 128 dimensions.

Similar to the operation of identity MLP 220, expression MLP 225 includes a multilayer perceptron (MLP) that translates the set of features included in expression code 210 to latent expression code γ including a potentially different set of latent features. In various embodiments, expression MLP 220 accepts the features included in expression code 210 as input, and processes the features via three fully connected layers to generate latent expression code γ having 128 dimensions.

In step 308, identity model 235 deforms the bone and skin geometries included in canonical space 230 based on latent identity code β to generate identity space 245. In various embodiments, identity model 235 includes a machine learning model having four Gaussian Error Linear Units (GeLU) that apply latent identity code β to the output of each of four 3D processing layers. A fifth 3D processing layer feeds into a linear output layer. The output of identity model 235 includes 3D pointwise deformations associated with each point included in canonical space 230 representing bones and skin. The soft tissue volume is defined as the locations between the deformed bones and the deformed skin. Identity model 235 applies the 3D pointwise deformations to canonical space 230 to generate identity space 245.

In step 310, expression model 240 modifies identity space 245 based on latent identity code β received from identity MLP 220 and latent expression code γ received from expression MLP 225. In various embodiments, the architecture of expression model 240 is the same or substantially similar to the architecture of identity model 235 discussed above. Based on the skin, skull, and jaw geometries included in identity space 245, expression model 240 infers a continuous muscle actuation field A(·) and a jaw transformation {R_{jaw}, t_{jaw}} to match a given expression associated with a 3D facial scan included in training data 200. In various embodiments, the skull geometry is held constant, and is not modified by expression model 240. Expression model 240 generates identity/expression space 250. Identity/expression space 250 includes an identity- and expression-specific representation of a facial model based on the deformation of canonical space 230 by identity model 235 and expression model 240.

Identity/expression space 250 includes multiple points defining the locations of skin, bones, and soft tissue included in the facial model. Training engine 122 defines the soft tissue volume as including all points located between the skin locations and bone locations as modified by the continuous muscle actuation field and jaw transformation calculated by expression model 240.

In step 312, training engine 122 iteratively modifies one or more adjustable model parameters based on identity/expression space 250 and ground truth skin geometry 215. Loss calculator 255 evaluates one or more loss and/or regulation functions on the outputs of identity model 235 and expression model 240. In various embodiments, loss calculator 255 evaluates four loss functions associated with the output of expression model 240. These functions may include reconstruction loss [symbol] ₛₖᵢₙ, rigidity loss [symbol] _{rigid}, fixation loss [symbol] _{fix}, and soft loss [symbol] _{soft}.

Loss calculator 255 also evaluates loss and/or regulation functions associated with the output of identity model 235. In various embodiments, these functions may include identity loss [symbol] _{id}, bone shape loss [symbol] _{bone}, and elastic regularization [symbol] _{ereg}.

Training engine 122 further regularizes the identity code β and the expression code γ using l−2 regularization [symbol] _{reg}=∥β∥₂²+∥γ∥₂². Training engine 122 also applies Lipschitz regularization [symbol] ₗᵢₚ to identity MLP 220 and expression MLP 225. Training engine 122 modifies one or more adjustable parameters included in identity MLP 220, expression MLP 225, identity model 235, and/or expression model 240 based on the above loss and regularization functions. The complete training objective function is given by:

$${ℒ}_{train} = {λ}_{skin} {ℒ}_{skin} + {λ}_{r i g i d} {ℒ}_{rigid} + {λ}_{f i x} {ℒ}_{f i x} + {λ}_{s o f t} {ℒ}_{soft} + {λ}_{i d} {ℒ}_{i d} + {λ}_{bone} {ℒ}_{bone} + {λ}_{ereg} {ℒ}_{ereg} + {λ}_{lreg} {ℒ}_{lreg} + {λ}_{lip} {ℒ}_{lip} , \qquad Equation ( 18 )$$

where λ_{*} are balancing weights. The entire model is trained end-to-end without the need for explicit simulation of bone, skin, or tissue volume geometries. The model is supervised only on ground truth skin geometry 215, while anatomical features such as bone shapes, jaw kinematics, and muscle actuations are inferred automatically by identity model 235 and expression model 240. In various embodiments, training engine 122 may iteratively modify the one or more adjustable model parameters for a predetermined number of iterations, for a predetermined amount of time, or until the training objective function [symbol] ₜᵣₐᵢₙ is below a predetermined threshold.

FIG. 4 is a more detailed illustration of inference engine 124 of FIG. 1, according to some embodiments. Inference engine 124 receives identity and expression codes 400 and transmits identity and expression codes 400 to training engine 122. Previously trained machine learning models included in training engine 122 process identity and expression codes 400 and generate identity space 245 and identity/expression space 250. Inference engine 124 generates facial animation 450 based on identity and expression codes 400. Inference engine 124 includes, without limitation, jaw transformation 410, actuation tensor 420, simulation mesh 430, and Finite Element Method (FEM) simulator 440.

Identity and expression codes 400 may be substantially similar to identity code 205 and expression code 210. Each of identity and expression codes 400 include a set of features encoding the identity and expression, respectively, associated with a facial model to be animated by inference engine 124. In various embodiments, each of identity and expression codes 400 may be generated from a 3D facial scan using any suitable 3D Morphing Model (3DMM). Alternatively, each of identity and expression codes 400 may be generated based on a 2D face image, such as a photograph, via any suitable facial landmark detection technique operable to generate a mesh representation from detected landmarks in a 2D face image.

Inference engine 124 transmits identity and expression codes 400 to training engine 122, where the various machine learning models included in training engine 122, such as identity MLP 220, expression MLP 225, identity model 235, and expression model 240, have been previously trained as discussed above in the description of FIG. 2. The various trained machine learning models included in training engine 122 process identity and expression codes 400 and generate identity space 245 and identity/expression space 250 as discussed above in the description of FIG. 2. Inference engine 124 receives identity space 245 and identity/expression space 250 from training engine 122.

Simulation mesh 430 includes a discretized depiction of the continuous pointwise facial skin surface included in identity space 245. In various embodiments, inference engine 124 generates simulation mesh 430 including multiple hexahedral elements, where each hexahedral element may be approximately 2 millimeters across. By varying the size of the multiple hexahedral elements, inference engine 124 may control the discretized resolution of simulation mesh 430. Inference engine 124 transmits simulation mesh 430 to actuation tensor 420 and FEM simulator 440.

Inference engine 124 extracts jaw transformation 410 {R_{jaw}, t_{jaw}} inferred by expression model 240 and included in identity/expression space 250. R_{jaw} represents a 3D rotation of the jaw bone included in the facial model, while t_{jaw} represents a 3D translation of the jaw bone. Inference engine 124 transmits jaw transformation 410 to FEM simulator 440.

Actuation tensor 420 includes discrete deformations associated with each element included in simulation mesh 430, based on the continuous pointwise actuation field A(·) calculated by expression model 240 and included in identity/expression space 250. Inference engine 124 discretizes continuous pointwise actuation field A(·) by defining a single tensor value for each element included in simulation mesh 430. In various embodiments, the single tensor value associated with a mesh element may be calculated based on applying continuous pointwise actuation field A(·) to a point corresponding to the center of a mesh element. Alternatively, the single tensor value associated with a mesh element may be calculated based on applying continuous pointwise actuation field A(·) to multiple vertices included in a mesh element and averaging the tensor values associated with the multiple vertices. Inference engine 124 transmits actuation tensor 420 to FEM simulator 440.

Finite Element Method (FEM) simulator 440 receives the jaw transformation, the discretized actuation tensor and the discretized simulation mesh, and generates facial animation 450. FEM simulator 440 may include any suitable physics-based model operable to generate animations based on discrete mesh elements, discrete tensor values, and specified bone transformations.

FEM simulator 440 may include collision handling techniques operable to detect and resolve model collisions, such as lip-lip and/or tooth-lip penetrations. FEM simulator 440 may also simulate various degrees of muscle paralysis by modifying actuation tensor 420 values associated with one or more mesh elements in simulation mesh 430. FEM simulator 440 may further support reshaping one or more bones in the facial model, as well as simulating the effects of gravity on soft tissues by applying a uniform directional force to values include in actuation tensor 420. FEM simulator 440 generates facial animation 450.

Facial animation 450 depicts the identity and expression specified by identity and expression codes 400. Facial animation 450 includes a mesh representation having elements defined by vertices, and may be further processed by any downstream software applications that are operable to utilize or modify mesh representations.

Inference engine 124 may be operable to perform physics-based animation retargeting, where facial animations may be transferred between identities. In various embodiments, for given source subject identity and expression codes, the source identity code may be replaced by a target subject identity code, while keeping the source latent expression code. In other embodiments, inference engine 124 may directly replace a source subject latent identity code with a target subject latent identity code, bypassing identity MLP 220. The generated facial animation 450 will then depict the target subject exhibiting the same expression as the source subject.

Inference engine 124 may also be operable to perform identity interpolation to generate novel identities from the identity space. In various embodiments, given a database including multiple identities and associated identity codes, such as training data 200 discussed above, inference engine 124 may interpolate between two user-specified identity codes to generate a novel identity code. Inference engine 124 may evaluate the novel identity code with different expression codes, enabling physics-based facial animations on novel identities. In other embodiments, inference engine 124 may interpolate between two user-specified latent identity codes directly, bypassing identity MLP 220.

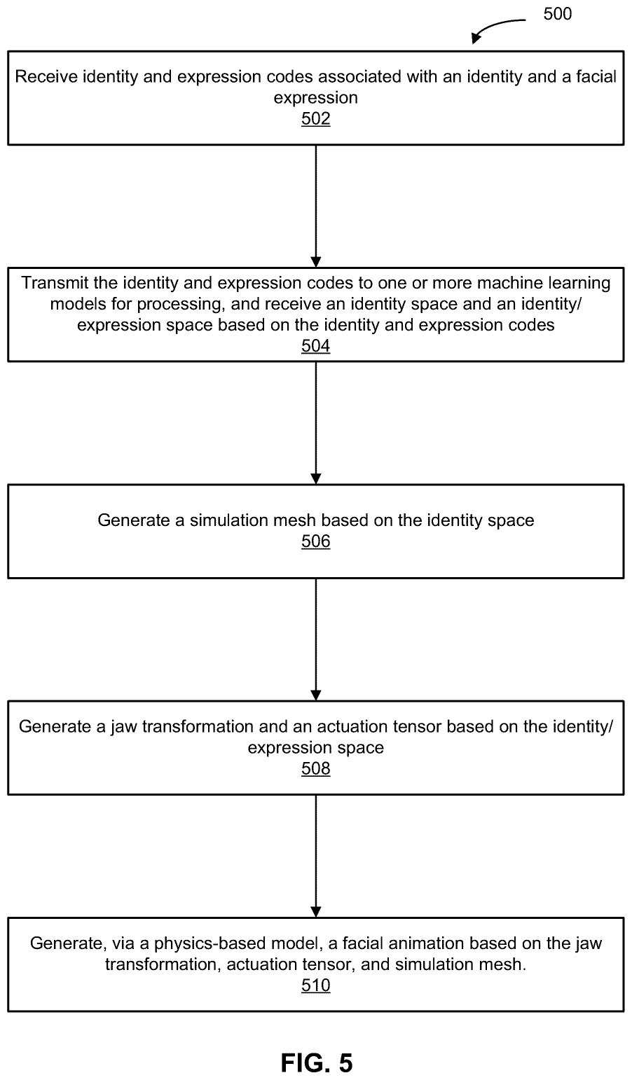

FIG. 5 is a flow diagram of method steps for generating a facial animation, according to some embodiments. Although the method steps are described in conjunction with the systems of FIGS. 1-2 and 4, persons skilled in the art will understand that any system configured to perform the method steps in any order falls within the scope of the present disclosure.

As shown, in step 502 of method 500, inference engine 124 receives identity and expression codes 400. Each of identity and expression codes 400 include a set of features encoding the identity and expression, respectively, associated with a facial model to be animated by inference engine 124. In various embodiments, each of identity and expression codes 400 may be generated from a 3D facial scan using any suitable 3D Morphing Model (3DMM). Alternatively, each of identity and expression codes 400 may be generated based on a 2D face image, such as a photograph, via any suitable facial landmark detection technique operable to generate a mesh representation based on detected landmarks in a 2D face image. A 3DMM may then process the generated mesh representation to generate identity and expression codes 400 in a similar manner as processing a 3D facial scan.

In step 502, inference engine 124 transmits identity and expression codes 400 to training engine 122 for processing via multiple previously trained machine learning models included in training engine 122, such as identity MLP 220, expression MLP 225, identity model 235, and expression model 240. Inference engine 124 receives identity space 245 and identity/expression space 250 from training engine 122, where identity space 245 and identity/expression space 250 are generated based on identity and expression codes 400.

In step 504, inference engine 124 generates simulation mesh 430 based on identity space 245. Simulation mesh 430 includes a discretized depiction of the continuous pointwise facial skin surface included in identity space 245. In various embodiments, inference engine 124 generates simulation mesh 430 including multiple hexahedral elements, where each hexahedral element may be approximately 2 millimeters across. By varying the size of the multiple hexahedral elements, inference engine 124 may control the discretized resolution of simulation mesh 430.

In step 506, inference engine 124 may generate simulation mesh 430 including a discretized depiction of the continuous pointwise facial skin surface included in identity space 245. In various embodiments, inference engine 124 generates simulation mesh 430 including multiple hexahedral elements, where each hexahedral element may be approximately 2 millimeters across. By varying the size of the multiple hexahedral elements, inference engine 124 may control the discretized resolution of simulation mesh 430. Inference engine 124 transmits simulation mesh 430 to actuation tensor 420 and FEM simulator 440.

In step 508, inference engine 124 generates jaw transformation 410 and actuation tensor 420 based on identity/expression space 250. Inference engine 124 extracts jaw transformation 410 {R_{jaw}, t_{jaw}} inferred by expression model 240 and included in identity/expression space 250. R_{jaw} represents a 3D rotation of the jaw bone included in the facial model, while t_{jaw} represents a 3D translation of the jaw bone. Inference engine 124 transmits jaw transformation 410 to FEM simulator 440.

Actuation tensor 420 includes discrete deformations associated with each element included in simulation mesh 430, based on the continuous pointwise actuation field A(·) calculated by expression model 240 and included in identity/expression space 250. Inference engine 124 discretizes continuous pointwise actuation field A(·) by defining a single tensor value for each element included in simulation mesh 430. In various embodiments, the single tensor value associated with a mesh element may be calculated based on applying continuous pointwise actuation field A(·) to a point corresponding to the center of a mesh element. Alternatively, the single tensor value associated with a mesh element may be calculated based on applying continuous pointwise actuation field A(·) to multiple vertices included in a mesh element and averaging the tensor values associated with the multiple vertices.

In step 510, inference engine 124 generates, via Finite Element Method (FEM) simulator 440, facial animation 450 based on jaw transformation 410, actuation tensor 420, and simulation mesh 430. FEM simulator 440 may include any suitable physics-based model operable to generate animations based on discrete mesh elements, discrete tensor values, and specified bone transformations.

FEM simulator 440 may include collision handling techniques operable to detect and resolve model collisions, such as lip-lip and/or tooth-lip penetrations. FEM simulator 440 may also simulate various degrees of muscle paralysis by modifying actuation tensor 420 values associated with one or more mesh elements in simulation mesh 430. FEM simulator 440 may further support reshaping one or more bones in the facial model, as well as simulating the effects of gravity on soft tissues by applying a uniform directional force to values include in actuation tensor 420. FEM simulator 440 generates facial animation 450.

Facial animation 450 depicts the identity and expression specified by identity and expression codes 400. Facial animation 450 includes a mesh representation having elements defined by vertices, and may be further processed by any downstream software applications that are operable to utilize or modify mesh representations.

Inference engine 124 may be operable to perform physics-based animation retargeting, where facial animations may be transferred between identities. In various embodiments, for given source subject identity and expression codes, the source identity code may be replaced by a target subject identity code, while keeping the source latent expression code. In other embodiments, inference engine 124 may directly replace a source subject latent identity code with a target subject latent identity code, bypassing identity MLP 220. The generated facial animation 450 will then depict the target subject exhibiting the same expression as the source subject.

Inference engine 124 may also be operable to perform identity interpolation to generate novel identities from the identity space. In various embodiments, given a database including multiple identities and associated identity codes, such as training data 200 discussed above, inference engine 124 may interpolate between two user-specified identity codes to generate a novel identity code. Inference engine 124 may evaluate the novel identity code with different expression codes, enabling physics-based facial animations on novel identities. In other embodiments, inference engine 124 may interpolate between two user-specified latent identity codes directly, bypassing identity MLP 220.

In sum, the disclosed techniques train multiple machine learning models to modify a canonical material space, where the canonical material space includes at least a skull, a jaw, skin, and a soft-tissue volume. The techniques modify the canonical material space based on identity and expression codes associated with a large number, e.g. thousands, of identity-specific 3D scans included in a training data set. For each 3D scan included in the training data set, the associated modified material space includes an identity-specific representation of the skull, jaw, skin, and soft-tissue, coupled with identity- and expression-specific muscle actuations and bone kinematics. The disclosed techniques train the machine learning models via supervision, based on ground truth skin representations associated with each of the 3D scans included in the training data set. The disclosed techniques further evaluate other loss and/or regularization terms to constrain physical properties associated with the modified material space, such as holding the skull position fixed, constraining the articulation of the jaw, and preserving the quantity of soft-tissue volume.

After training, the machine learning models are operable to generate a material space and associated actuations and bone kinematics based on any input identity and/or expression codes. The generated identity-specific material space and identity- and expression-specific actuations and bone kinematics, when applied to a physics simulator, allow for physics-based, identity-specific simulation and animation, including simulation and animation of identities that were not previously seen by the machine learning models during training.

In operation, a training engine receives a 3D facial scan including an associated identity code, an associated expression code, and associated ground truth skin geometry from a training data set. Each of the identity code and the expression code includes a set of features encoding the identity and expression, respectively, associated with the 3D facial scan. In various embodiments, each identity code and expression code are precomputed based on the associated 3D facial scan using any suitable 3D Morphing Model (3DMM). The ground truth skin geometry associated with each 3D facial scan is derived directly from the 3D facial scan, as the 3D facial scan represents the visible skin surface.

An identity Multilayer Perceptron (MLP) included in the training engine transforms the identity code into a latent identity code β including a potentially different set of latent features than those included in the identity code. Similarly, an expression MLP included in the training engine transforms the expression code into a latent expression code γ including a potentially different set of latent features than those included in the expression code.

The training engine generates a canonical space, including undeformed bone, skin, and soft tissue geometries associated with a neutral expression 3D facial scan included in the training data set corresponding to the identity encoded by the identity code. The bone geometry may include separate skull and jaw geometries. The training engine morphs the canonical space via an identity model and an expression model, based on the latent identity code β and/or the latent expression code γ.

The identity model deforms bone and skin points included in the canonical space based on latent identity code β received from the identity MLP, and generates an identity-specific identity space. The output of the identity model includes 3D pointwise deformations associated with each point included in the canonical space representing bones and skin. The identity model applies the 3D pointwise deformations to the canonical space to generate an identity space. The identity space includes an identity-specific representation of a facial model based on the deformation of the canonical space by the identity model. The identity space includes multiple points defining the locations of skin, bones, and soft tissue included in the facial model. The training engine defines the soft tissue volume as including all points between the deformed skin locations and bone locations generated by the identity model 235.

The expression model modifies the identity space based on latent identity code β received from the identity MLP and latent expression code γ received from the expression MLP. Based on the skin, skull, and jaw geometries included in the identity space, the expression model infers a continuous muscle actuation field A(·) and a jaw transformation {R_{jaw}, t_{jaw}} to match a given expression associated with a 3D facial scan included in the training data set. In various embodiments, the skull geometry may be held constant, and is not modified by the expression model. The expression model generates an identity/expression space including skull, jaw, skin, and tissue geometries, as well as the inferred continuous muscle actuation field and the jaw transformation.

The training engine modifies one or more adjustable parameters included in the identity MLP, the expression MLP, the identity model, and the expression model, based on the evaluation of multiple loss and regularization functions. The multiple loss and regularization function may include a reconstruction loss, a rigidity loss, a fixation loss, a soft-tissue loss, an identity loss, a bone shape loss, and an elastic regularization term. The training engine may iteratively modify the one or more adjustable parameters for a predetermined number of iterations, for a predetermined amount of time, or until a combination of one or more loss and/or regularization function values is below a predetermined threshold.

At inference time, an inference engine receives identity and expression codes associated with an identity and expression to be animated. The inference engine transmits the identity and expression codes to the training engine, where the previously trained machine learning models included in the training engine generate an identity space and an identity/expression space based on the identity and expression codes. The inference engine generates a discretized simulation mesh including multiple polygonal elements representing a skin surface. The inference engine also discretizes the continuous muscle actuation field by generating a single muscle actuation tensor value associated with each polygonal element included in the simulation mesh. The inference engine further extracts a jaw transformation from the identity/expression space that describes a 3D rotation and a 3D translation associated with a jaw bone included in the facial model. The inference engine transmits the jaw transformation, the muscle actuation tensor, and the simulation mesh to a Finite Element Method (FEM) physics-based model. The FEM model generates a facial animation based on the jaw transformation, the muscle actuation tensor, and the simulation mesh. The facial animation exhibits an identity associated with the latent identity code and an expression associated with the latent expression code.

In various embodiments, the inference engine may be operable to perform physics-based animation retargeting, where facial animations may be transferred between identities. For given source subject identity and expression codes, the source identity code may be replaced by a target subject identity code, while keeping the source expression code. The generated facial animation will then depict the target subject exhibiting the same expression as the source subject. Similarly, a target subject latent identity code may be substituted for a source latent identity code, bypassing the identity MLP.

The inference engine may also be operable to perform latent space interpolation to generate novel identities from the identity latent space. Given a database including multiple identities and associated identity codes, the inference engine may interpolate between two user-specified identity codes to generate a novel identity code. The inference engine may evaluate the novel identity code with different expression codes, enabling physics-based facial animations on novel identities. Alternatively, the inference engine may interpolate between two user-specified latent identity codes, bypassing the identity MLP.

One technical advantage of the disclosed techniques relative to the prior art is that the disclosed techniques produce a fully generalized 3D physics-based face model trained on a large number, e.g., hundreds, of subject identities, without requiring manual per-identity configuration. The generalized physics-based face model may then be fit to any new identity, including identities not seen during training, and generate identity-aware muscle actuations which may be utilized to create identity-specific facial animations via physics-based animation techniques. The generalized physics-based face model may also be sampled in latent space to generate novel synthetic identities. These technical advantages provide one or more improvements over prior art approaches.

1. In some embodiments, a computer-implemented method for generating a facial animation, the computer-implemented method comprises receiving an identity code including a first set of features describing a neutral facial depiction associated with a particular identity, receiving an expression code including a second set of features describing a facial expression associated with the particular identity, generating, via a first machine learning model, an identity-specific facial representation based on a canonical facial representation and the identity code, generating, via a second machine learning model and based on the identity code, the expression code, and the identity-specific facial representation, a muscle actuation field tensor and one or more bone transformations associated with the deformed canonical facial representation, and generating, via a physics-based simulator, a facial animation based on at least the muscle actuation field tensor and the one or more bone transformations.

2. The computer-implemented method of clause 1, further comprising generating a simulation mesh based on the identity-specific facial representation, wherein generating the facial animation is based at least on the simulation mesh.

3. The computer-implemented method of clauses 1 or 2, further comprising generating, based on the muscle actuation field tensor, tensor values associated with each of one or more mesh elements included in the simulation mesh.

4. The computer-implemented method of any of clauses 1-3, wherein the one or more bone transformations include a jaw translation and a jaw rotation.

5. The computer-implemented method of any of clauses 1-4, further comprising iteratively modifying one or more adjustable parameters included in one or more of the first machine learning model and the second machine learning model, based on calculated values associated with one or more loss functions.

6. The computer-implemented method of any of clauses 1-5, wherein the one or more loss functions include an identity loss, a bone shape loss, an elastic regularization loss, and a reconstruction loss.

7. The computer-implemented method of any of clauses 1-6, wherein the canonical facial representation describes the locations of skin, soft tissue, and one or more bones.

8. The computer-implemented method of any of clauses 1-7, wherein the one or more bones include at least a skull and a jaw.

9. The computer-implemented method of any of clauses 1-8, wherein the physics-based simulator includes a Finite Element Method (FEM) simulator.

10. In some embodiments, one or more non-transitory computer-readable media store instructions that, when executed by one or more processors, cause the one or more processors to perform the steps of receiving an identity code including a first set of features describing a neutral facial depiction associated with a particular identity, receiving an expression code including a second set of features describing a facial expression associated with the particular identity, generating, via a first machine learning model, an identity-specific facial representation based on a canonical facial representation and the identity code, generating, via a second machine learning model and based on the identity code, the expression code, and the identity-specific facial representation, a muscle actuation field tensor and one or more bone transformations associated with the deformed canonical facial representation, and generating, via a physics-based simulator, a facial animation based on at least the muscle actuation field tensor and the one or more bone transformations.

11. The one or more non-transitory computer-readable media of clause 10, further comprising generating a simulation mesh based on the identity-specific facial representation, wherein generating the facial animation is based at least on the simulation mesh.

12. The one or more non-transitory computer-readable media of clauses 10 or 11, further comprising generating, based on the muscle actuation field tensor, tensor values associated with each of one or more mesh elements included in the simulation mesh.

13. The one or more non-transitory computer-readable media of any of clauses 10-12, wherein the one or more bone transformations include a jaw translation and a jaw rotation.

14. The one or more non-transitory computer-readable media of any of clauses 10-13, further comprising iteratively modifying one or more adjustable parameters included in one or more of the first machine learning model and the second machine learning model, based on calculated values associated with one or more loss functions.

15. The one or more non-transitory computer-readable media of any of clauses 10-14, wherein the one or more loss functions include an identity loss, a bone shape loss, an elastic regularization loss, and a reconstruction loss.

16. The one or more non-transitory computer-readable media of any of clauses 10-15, wherein the canonical facial representation describes the locations of skin, soft tissue, and one or more bones.

17. The one or more non-transitory computer-readable media of any of clauses 10-16, wherein the one or more bones include at least a skull and a jaw.

18. The one or more non-transitory computer-readable media of any of clauses 10-17, wherein the physics-based simulator includes a Finite Element Method (FEM) simulator.

19. In some embodiments, a system comprises one or more memories storing instructions, and one or more processors for executing the instructions to receive an identity code including a first set of features describing a neutral facial depiction associated with a particular identity, receive an expression code including a second set of features describing a facial expression associated with the particular identity, generate, via a first machine learning model, an identity-specific facial representation based on a canonical facial representation and the identity code, generate, via a second machine learning model and based on the identity code, the expression code, and the identity-specific facial representation, a muscle actuation field tensor and one or more bone transformations associated with the deformed canonical facial representation, and generate, via a physics-based simulator, a facial animation based on at least the muscle actuation field tensor and the one or more bone transformations.

20. The system of clause 19, wherein the canonical facial representation describes the locations of skin, soft tissue, and one or more bones.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating a facial animation, the computer-implemented method comprising:
receiving an identity code including a first set of features describing a neutral facial depiction associated with a particular identity;
receiving an expression code including a second set of features describing a facial expression associated with the particular identity;
generating, via a first machine learning model, an identity-specific facial representation based on a canonical facial representation and the identity code;
generating, via a second machine learning model and based on the identity code, the expression code, and the identity-specific facial representation, a muscle actuation field tensor and one or more bone transformations associated with the canonical facial representation; and
generating, via a physics-based simulator, a facial animation based on at least the muscle actuation field tensor and the one or more bone transformations.

2. The computer-implemented method of claim 1, further comprising generating a simulation mesh based on the identity-specific facial representation, wherein generating the facial animation is based at least on the simulation mesh.

3. The computer-implemented method of claim 2, further comprising generating, based on the muscle actuation field tensor, tensor values associated with each of one or more mesh elements included in the simulation mesh.

4. The computer-implemented method of claim 1, wherein the one or more bone transformations include a jaw translation and a jaw rotation.

5. The computer-implemented method of claim 1, further comprising iteratively modifying one or more adjustable parameters included in one or more of the first machine learning model and the second machine learning model, based on calculated values associated with one or more loss functions.

6. The computer-implemented method of claim 5, wherein the one or more loss functions include an identity loss, a bone shape loss, an elastic regularization loss, and a reconstruction loss.

7. The computer-implemented method of claim 1, wherein the canonical facial representation describes locations associated with skin, soft tissue, and one or more bones.

8. The computer-implemented method of claim 7, wherein the one or more bones include at least a skull and a jaw.

9. The computer-implemented method of claim 1, wherein the physics-based simulator includes a Finite Element Method (FEM) simulator.

10. One or more non-transitory computer-readable media storing instructions that, when executed by one or more processors, cause the one or more processors to perform the steps of:
receiving an identity code including a first set of features describing a neutral facial depiction associated with a particular identity;
receiving an expression code including a second set of features describing a facial expression associated with the particular identity;
generating, via a first machine learning model, an identity-specific facial representation based on a canonical facial representation and the identity code;
generating, via a second machine learning model and based on the identity code, the expression code, and the identity-specific facial representation, a muscle actuation field tensor and one or more bone transformations associated with the canonical facial representation; and
generating, via a physics-based simulator, a facial animation based on at least the muscle actuation field tensor and the one or more bone transformations.

11. The one or more non-transitory computer-readable media of claim 10, further comprising generating a simulation mesh based on the identity-specific facial representation, wherein generating the facial animation is based at least on the simulation mesh.

12. The one or more non-transitory computer-readable media of claim 11, further comprising generating, based on the muscle actuation field tensor, tensor values associated with each of one or more mesh elements included in the simulation mesh.

13. The one or more non-transitory computer-readable media of claim 10, wherein the one or more bone transformations include a jaw translation and a jaw rotation.

14. The one or more non-transitory computer-readable media of claim 10, further comprising iteratively modifying one or more adjustable parameters included in one or more of the first machine learning model and the second machine learning model, based on calculated values associated with one or more loss functions.

15. The one or more non-transitory computer-readable media of claim 14, wherein the one or more loss functions include an identity loss, a bone shape loss, an elastic regularization loss, and a reconstruction loss.

16. The one or more non-transitory computer-readable media of claim 10, wherein the canonical facial representation describes locations associated with skin, soft tissue, and one or more bones.

17. The one or more non-transitory computer-readable media of claim 16, wherein the one or more bones include at least a skull and a jaw.

18. The one or more non-transitory computer-readable media of claim 10, wherein the physics-based simulator includes a Finite Element Method (FEM) simulator.

19. A system comprising:
one or more memories storing instructions; and
one or more processors for executing the instructions to:
receive an identity code including a first set of features describing a neutral facial depiction associated with a particular identity;
receive an expression code including a second set of features describing a facial expression associated with the particular identity;
generate, via a first machine learning model, an identity-specific facial representation based on a canonical facial representation and the identity code;
generate, via a second machine learning model and based on the identity code, the expression code, and the identity-specific facial representation, a muscle actuation field tensor and one or more bone transformations associated with the canonical facial representation; and
generate, via a physics-based simulator, a facial animation based on at least the muscle actuation field tensor and the one or more bone transformations.

20. The system of claim 19, wherein the canonical facial representation describes locations associated with skin, soft tissue, and one or more bones.
